(19) United States
(12) Patent Application Publication
(10) Pub. No.: US 2010/0095597 A1
(43) Pub. Date: Apr. 22, 2010

(54) Spacer for use in connecting a door panel to a cabinet structure

(76) Inventor: Nicholas Theodore Zounis, JR., Lake Worth, FL (US)

Correspondence Address: L. Jon Lindsay, 342 Litchfield Ln., Houston, TX, 77024, US

(21) Appl. No.: 12/288,474

(22) Filed: Oct. 21, 2008

(51) Int. Cl. E05D 11/06; E06B 3/96

(52) U.S. Cl. 49/383; 49/506

(57) ABSTRACT

A spacer is described for placing onto a door panel to assist when connecting the door panel to a cabinet structure. The spacer includes gripping portions and a spacing portion. The gripping portions hold onto the door panel near an edge of the door panel when the spacer is placed onto the door panel. The spacing portion holds the gripping portions in alignment with each other and is held adjacent to the edge of the door panel when the gripping portions hold onto the door panel. When the edge of the door panel with the spacer placed thereon is held against the cabinet structure, the spacing portion causes a gap between the door panel and the cabinet structure, which enables a hinged connection to be made between the door panel and the cabinet structure with a spacing that allows the door panel to close against the cabinet structure after the spacer has been removed from the door panel.

### BACKGROUND OF THE INVENTION

There are many styles of cabinets, each having a variety of distinctive features. One of the most common features is a door panel attached by hinges to the rest of the cabinet structure. The door panel and hinges must be properly aligned and mounted to the cabinet structure for the door panel to open and dose smoothly and to close square with the cabinet structure.

Most cabinet/hinge/door styles, designs or configurations require that the door panel be spaced away from the cabinet structure when open, in order for the door panel to be properly flush or square with the cabinet structure when closed. Additionally, in many of these situations, the door panel must be held in the open position when attaching the door panel to the cabinet structure. Otherwise, it would be impossible to physically reach the hinges if the door panel were to be held in the closed position when attaching it to the cabinet structure. It can be very difficult, therefore, to hold the door panel up to the cabinet structure while attaching the hinges to the cabinet structure, the door panel or both, because the door panel has to be held away from the cabinet structure.

A very steady hand is, thus, needed to hold the door panel during installation. Otherwise, there exists a very high risk that the cabinet could be severely damaged or disfigured requiring costly or time-consuming repairs to or replacement of part or all of the cabinet

### BRIEF DESCRIPTION OF THE DRAWINGS

FIG. 1 is a side view of a spacer according to an embodiment of the present invention.

FIG. 2 is an exploded perspective view of the spacer shown in FIG. 1, according to an embodiment of the present invention.

FIG. 3 is a perspective view of the spacer shown in FIG. 1, according to an embodiment of the present invention.

FIG. 4 is a perspective view of the spacer shown in FIG. 1 with a door panel and cabinet structure and an enlargement of a portion thereof, according to an embodiment of the present invention.

FIG. 5 is a top view of the spacer, the door panel and the cabinet structure shown in FIG. 4 with an enlargement of a portion thereof, according to an embodiment of the present invention.

FIG. 6 is a perspective view of the door panel and the cabinet structure shown in FIGS. 4 and 5 with the door panel in an open position.

FIG. 7 is another perspective view of the door panel and the cabinet structure shown in FIGS. 4 and 5 with the door panel in a closed position.

FIG. 8 is a top view of the door panel and the cabinet structure shown in FIGS. 4 and 5 with the door panel in a closed position.

FIG. 9 is a perspective view of a first alternative spacer, according to an embodiment of the present invention.

FIG. 10 is a perspective view of a second alternative spacer, according to an embodiment of the present invention.

FIG. 11 is a perspective view of a third alternative spacer, according to an embodiment of the present invention.

FIG. 12 is a perspective view of a fourth alternative spacer, according to an embodiment of the present invention.

### DETAILED DESCRIPTION OF THE INVENTION

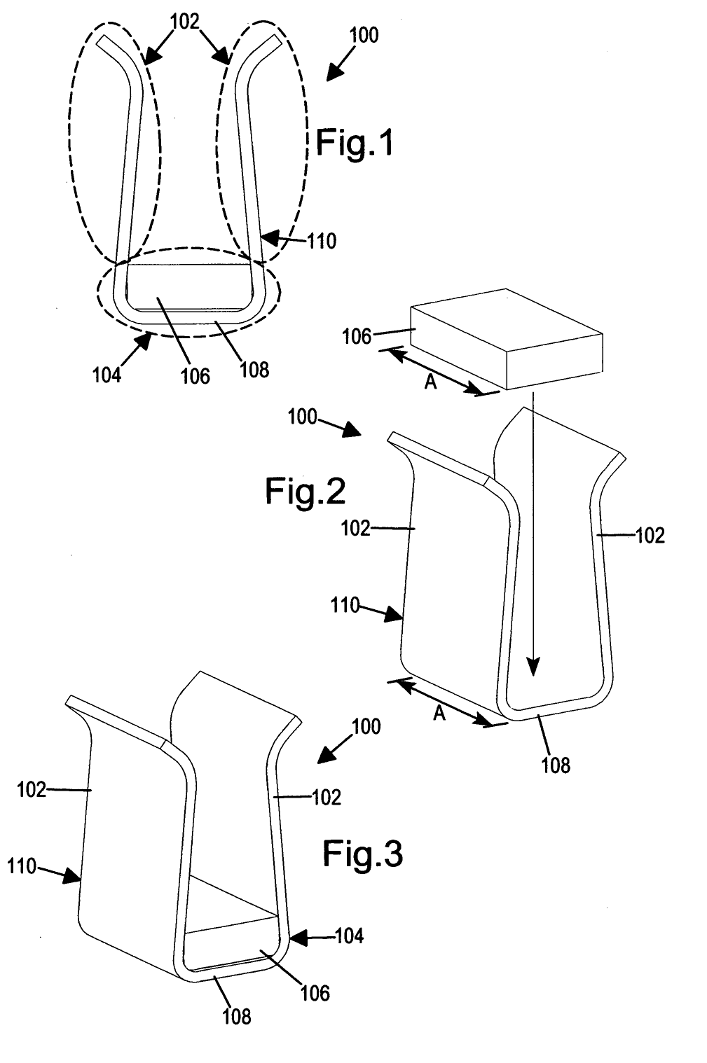

An exemplary spacer 100 for placing onto a door panel (not shown) to assist when connecting the door panel to a cabinet structure (not shown) is shown in FIGS. 1, 2 and 3. Use of the spacer 100 makes it easy to hold the door panel in a proper position relative to the cabinet structure, so that a hinged connection can quickly and easily be made between the door panel and the cabinet structure, as described below.

According to an embodiment of the present invention, the spacer 100 generally includes gripping portions 102 and a spacing portion 104. The spacing portion 104 generally includes a block 106 and a bottom portion 108. The bottom portion 108 and the gripping portions 102 together form a main body portion 110 of the spacer 100.

According to the example shown, the bottom portion 108 of the spacing portion 104 holds the gripping portions 102 in alignment with each other. The gripping portions 102 are preferably angled toward each other as they extend from the bottom portion 108. At distal ends, however, the gripping portions 102 curve outwardly. The main body portion 110 and the block 106 extend for any appropriate length in direction A. It is understood, however, that the present invention is not necessarily limited to the particular geometry shown and described, but that other geometrical shapes for various portions of the spacer 100 are within the scope of the present invention.

The block 106 sits adjacent the bottom portion 108. The block 106 may be attached to the bottom portion 108 (e.g. by glue, etc.) or held in place by force and friction from the bottom portion 108 and the proximal ends of the gripping portions 102. Thus, the block 106 may be made of any appropriate material, such as plastic, wood, metal, cardboard, etc.

According to various embodiments, the main body portion 110 is a single, integral, generally U-shaped article. The main body portion 110 may be made of any appropriate material, such as plastic, metal, etc. The main body portion 110 may be formed by molding, folding, stamping or any other process appropriate for the chosen material.

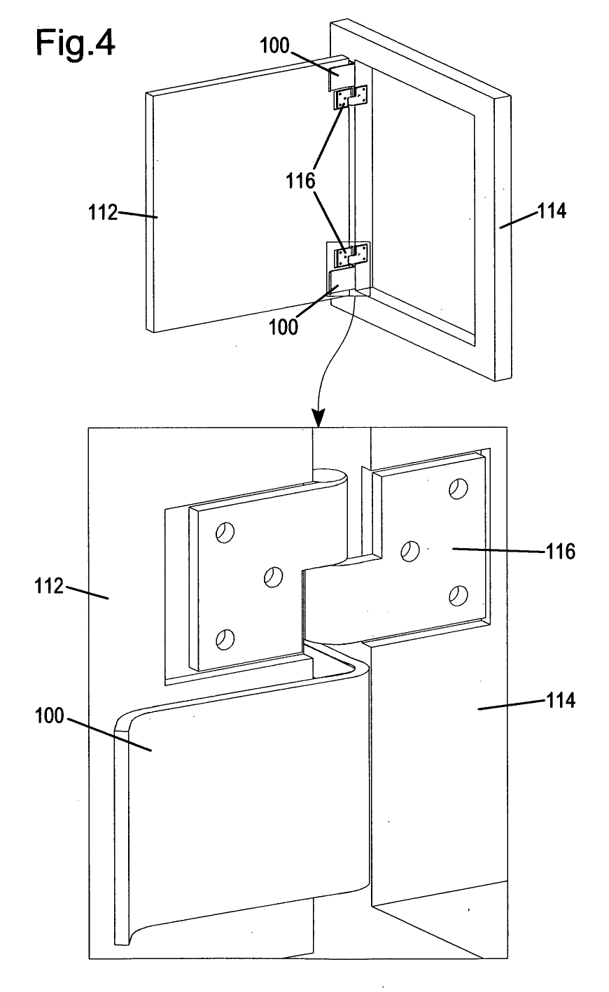

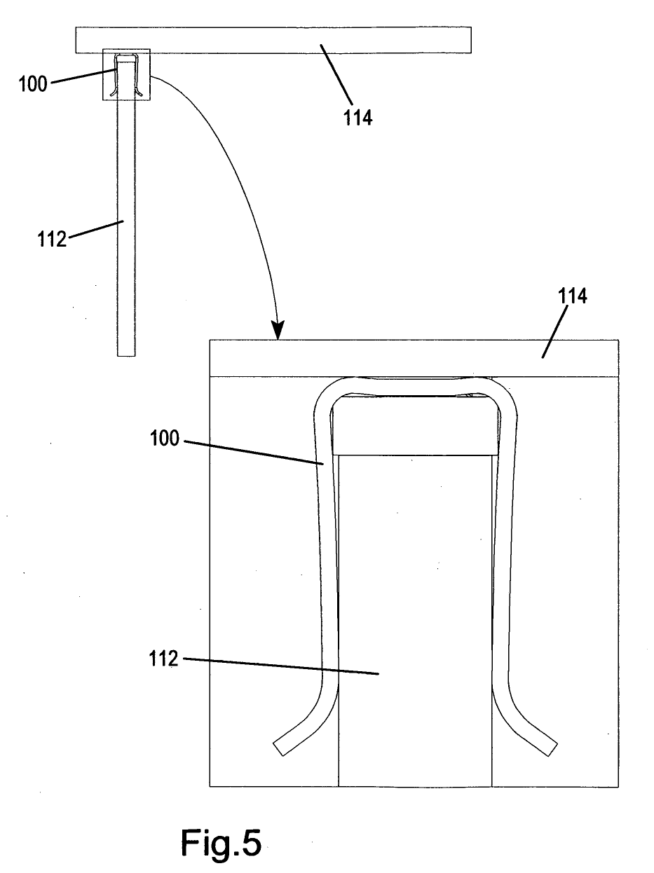

The outwardly curving distal ends of the gripping portions 102 allow the spacer 100 to be easily slid onto an edge of a door panel 112 to a position as shown in FIGS. 4 and 5. Two spacers 100 are shown in FIG. 4 placed onto the edge of the door panel 112, one spacer 100 near the top of the door panel 100, and one spacer 100 near the bottom. In actual practice, any number of the spacers 100 may be placed onto the door panel 112 at any appropriate locations.

The space between the gripping portions 102 is preferably smaller than the thickness of the edge of the door panel 112 on which the spacer 100 will be used. As a result, when the spacer 100 is slid onto the edge of the door panel 112, the gripping portions 102 will bow slightly outward. The main body portion 110 of the spacer 100, thus, preferably has a sufficient flexibility to allow the gripping portions 102 to bow outward. Additionally, the main body portion 110 of the spacer 100 preferably has a sufficient rigidity to cause an inward force from the gripping portions 102 against the opposite surfaces of the door panel 112. The force of the contact between the gripping portions 102 and the door panel 112 along with the friction between the contacting surfaces holds the spacer 100 on the edge of the door panel 112. It is understood, however, that this particular method of holding the spacer 100 on the edge of the door panel 112 is given for illustrative purposed only and that the invention is not necessarily limited to this particular method. Thus, other means and methods of holding the spacer 100 on the edge of the door panel 112 are within the scope of the present invention.

With one or more of the spacers 100 placed on the edge of the door panel 112, the edge of the door panel 112 is held against a cabinet structure 114 as shown in FIGS. 4 and 5. In this position, the spacing portion 104 of the spacer(s) 100 causes a gap between the door panel 112 and the cabinet structure 114. In this manner, the door panel 112 is held firmly against the cabinet structure 114, but is spaced away from the cabinet structure 114 by the thickness of the spacing portion 104. The spacing is an appropriate distance that enables a proper hinged connection to be made between the door panel 112 and the cabinet structure 114. Thus, while the door panel 112 with the spacer(s) 100 is held against the cabinet structure 114, a hinge 116 can be attached to the door panel 112 and the cabinet structure 114. A person installing the door panel 112 onto the cabinet structure 114, thus, can easily hold the door panel 112 steady in a preferred position while attaching the hinge 116.

Alternatively, while holding the door panel 112 (with one or more of the spacers 100) against the cabinet structure 114, the door panel 112 or the cabinet structure 114 (or both) is simply marked with locations for screws (or other hinge attachment devices or means). Then the door panel 112 and cabinet structure 114 can be prepared (e.g. drilling screw holes) while not holding the door panel 112 against the cabinet structure 114. Then the actual attachment of the door panel 112 to the cabinet structure 114 can be done without the spacer 100 placed onto the door panel 112. This alternative may be preferable in situations where the design or geometry of the door panel 112 and/or the cabinet structure 114 makes it difficult to remove the spacer 100 from the door panel 112 after the door panel 112 has been attached to the cabinet structure 114.

In another alternative, the hinge 116 is attached to one of either the door panel 112 or the cabinet structure 114 before the door panel 112 is held against the cabinet structure 114, so the hinge 116 only has to be connected to the other one of the cabinet structure 114 or door panel 112 while holding the door panel 112 against the cabinet structure 114. Other alternative ways of using the spacer 100 are also within the scope of the present invention.

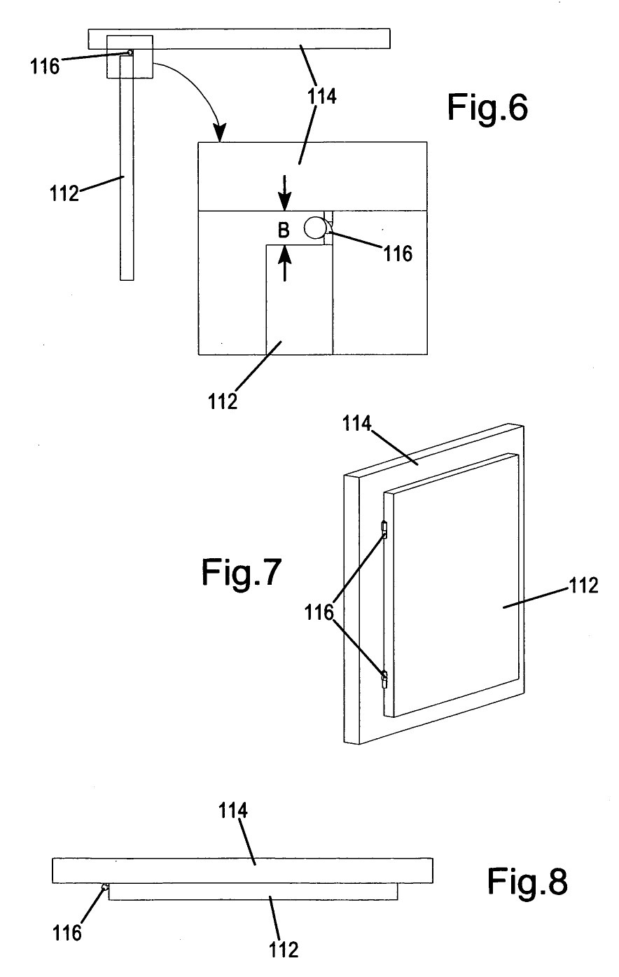

As a result of using one or more of the spacers 100 to attach the door panel 112 to the cabinet structure 114, there remains a proper spacing B between the door panel 112 and the cabinet structure 114 after the spacer(s) 100 has been removed from the door panel 112, as shown in FIG. 6. In this position, the door panel 112 can be properly closed against the cabinet structure 114, as shown in FIGS. 7 and 8.

The exact configuration, design or geometry of door panel 112, cabinet structure 114 and hinges 116 shown in FIGS. 4-8 is presented for simplified illustrative purposes only. It is understood that the invention is not limited to this particular configuration, design or geometry. Instead, the spacer 100 can be used with other configurations, designs or geometries for the door panel 112, cabinet structure 114 and/or hinges 116.

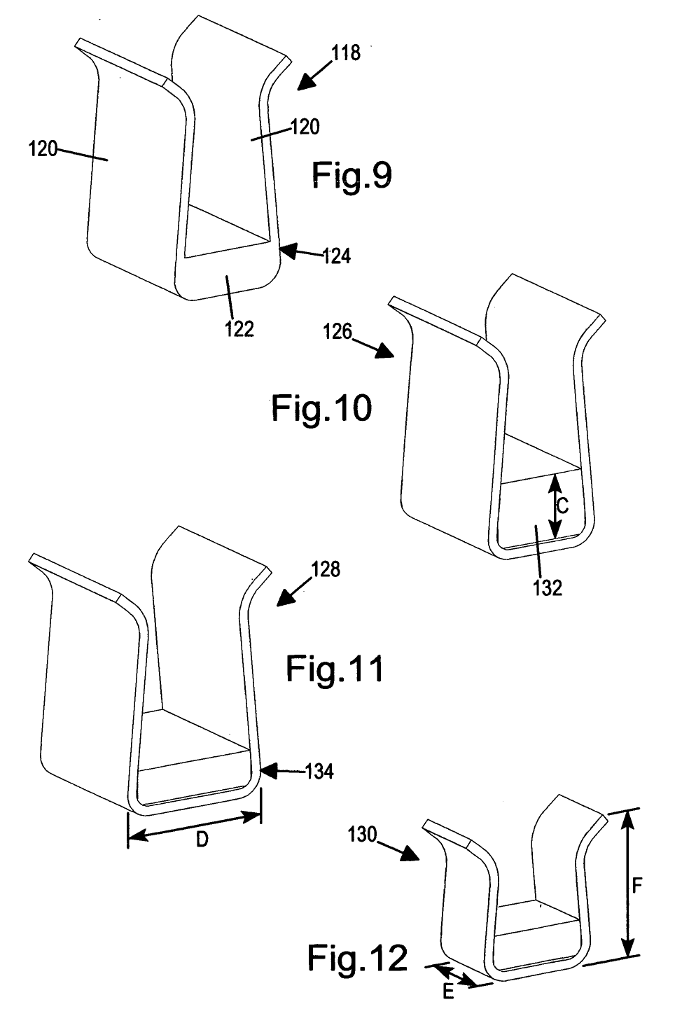

A first alternative embodiment for a spacer 118, used in a similar manner as the spacer 100, is shown in FIG. 9. The spacer 118 generally includes gripping portions 120 and a spacing portion 122. But the spacing portion 122 does not need the block 106 (FIGS. 1-3). (Although, the block 106 could be optional in some variations of this embodiment.) Instead, the entire spacing portion 122 is similar to the bottom portion 108 (FIGS. 1-3) in that the spacing portion 122 and the gripping portions 120 together form a main body portion 124 of the spacer 118. However, the spacing portion 122 is thicker than the bottom portion 108, so the spacing portion 122 serves the function of both the bottom portion 108 and the block 106. In other words, the extra thick spacing portion 122 causes the spacing between the door panel 112 (FIGS. 4 and 5) and the cabinet structure 114 (FIGS. 4 and 5), without the need for the block 106, when holding the door panel 112 against the cabinet structure 114. The actual thickness of the spacing portion 122, thus, depends on the amount of space needed between the door panel 112 and the cabinet structure 114.

Additional alternative embodiments for a spacer 126,128 or 130, used in a similar manner as either the spacer 100 or the spacer 118, are shown in FIGS. 10, 11 and 12, respectively. The spacer 126 illustrates an embodiment in which the thickness C of a block 132 (FIG. 10) may be different to accommodate different requirements for the spacing B (FIG. 6) between the door panel 112 and the cabinet structure 114. The spacer 128 illustrates an embodiment in which the width D of a spacing portion 134 (FIG. 11) may be different to accommodate different thicknesses of the door panel 112. The spacer 130 illustrates an embodiment in which the depth E or height F of the spacer 130 (FIG. 12) may be different. In other words, the various spacers 100, 118, 126, 128 or 130 may have any of a variety of combinations of sizes, shapes and configurations. In fact, a variety of different spacers 100, 118, 126, 128 or 130 may be sold together in a kit or set, so that a person using the spacers 100, 118, 126, 128 or 130 would be able to handle almost any anticipated size, shape, design, configuration or geometry of door panel 112, cabinet structure 114 and hinges 116.

The invention claimed is:

1. A spacer for placing onto a door panel to assist when connecting the door panel to a cabinet structure, comprising:
gripping portions that hold onto the door panel near an edge of the door panel when the spacer is placed onto the door panel; and
a spacing portion that holds the gripping portions in alignment with each other and that is held adjacent to the edge of the door panel when the gripping portions hold onto the door panel;
and wherein, when the edge of the door panel with the spacer placed thereon is held against the cabinet structure, the spacing portion causes a gap between the door panel and the cabinet structure, which enables a hinged connection to be made between the door panel and the cabinet structure with a spacing that allows the door panel to close against the cabinet structure after the spacer has been removed from the door panel.

2. The spacer of claim 1, wherein:
the gripping portions are angled toward each other and bow outwardly when the spacer is placed onto the door panel to create an inward force with which the gripping portions engage opposite sides of the door panel.

3. The spacer of claim 1, wherein:
the spacing portion further comprises a block of material that touches the edge of the door panel when the spacer is placed onto the door panel and that causes at least part of the gap between the door panel and the cabinet structure when the edge of the door panel with the spacer placed thereon is held against the cabinet structure.

4. The spacer of claim 3, wherein:
the block of material has a thickness and is removable from the spacer and replaceable with another block of material having a different thickness.

5. The spacer of claim 1, wherein:
the gripping portions and the spacing portion form a single, integral, generally U-shaped article.

6. The spacer of claim 5, wherein:
the spacing portion is thicker than the gripping portions, and the thickness of the spacing portion determines the gap between the door panel and the cabinet structure when the edge of the door panel with the spacer placed thereon is held against the cabinet structure.

7. A method of attaching a door panel to a cabinet structure comprising:
placing a spacer onto an edge of the door panel;
holding the door panel to the cabinet structure, with the spacer causing a gap between the edge of the door panel and the cabinet structure;
making a hinged connection between the door panel and the cabinet structure, with a proper spacing that allows the door panel to properly close against the cabinet structure; and
removing the spacer from the door panel.

8. The method of claim 7, wherein the aforementioned spacer is a first spacer, further comprising:
placing the first spacer on the edge of the door panel near a first corner of the door panel; and
placing a second spacer on the edge of the door panel near a second corner of the door panel;
and wherein both the first spacer and the second spacer cause the gap between the edge of the door panel and the cabinet structure.

9. The method of claim 7, wherein the spacer comprises:
gripping portions that hold onto the door panel near the edge of the door panel when the spacer is placed onto the door panel; and
a spacing portion that holds the gripping portions in alignment with each other and that is held adjacent to the edge of the door panel when the gripping portions hold onto the door panel.

10. The method of claim 9, wherein:
the gripping portions of the spacer are angled toward each other and bow outwardly when the spacer is placed onto the door panel to create an inward force with which the gripping portions engage opposite sides of the door panel.

11. The method of claim 9, wherein:
the spacing portion of the spacer further comprises a block of material that touches the edge of the door panel when the spacer is placed onto the door panel and that causes at least part of the gap between the door panel and the cabinet structure when the edge of the door panel with the spacer placed thereon is held against the cabinet structure.

12. The method of claim 11, wherein:
the block of material has a thickness and is removable from the spacer and replaceable with another block of material having a different thickness, the spacer then causing a different-sized gap between the edge of the door panel and the cabinet structure.

13. The method of claim 9, wherein:
the gripping portions and the spacing portion form a single, integral, generally U-shaped article.

14. The method of claim 13, wherein:
the spacing portion is thicker than the gripping portions, and the thickness of the spacing portion determines the gap between the door panel and the cabinet structure when the edge of the door panel with the spacer placed thereon is held against the cabinet structure.

15. A spacer for placing onto a door panel to assist when connecting the door panel to a cabinet structure, comprising:
a means for gripping the door panel near an edge of the door panel when the spacer is placed on the door panel; and
a means for spacing the edge of the door panel from the cabinet structure when the edge of the door panel is held against the cabinet structure;
and wherein, when the door panel with the spacer placed thereon is held against the cabinet structure, the spacing means enables a hinged attachment to be made between the door panel and the cabinet structure with a spacing that allows the door panel to be closed against the cabinet structure after the spacer has been removed from the door panel.

16. The spacer of claim 15, wherein:
the gripping means comprise two such means that are angled toward each other and bow outwardly when the spacer is placed onto the door panel to create an inward force with which the gripping means engage opposite sides of the door panel.

17. The spacer of claim 15, wherein:
the spacing means further comprises a means for creating part of a gap between the door panel and the cabinet structure when the door panel with the spacer placed thereon is held against the cabinet structure; and
the gap creating means touches the edge of the door panel when the spacer is placed onto the door panel.

18. The spacer of claim 17, wherein:
the gap creating means has a thickness and is removable from the spacer and replaceable with another gap creating means having a different thickness.

19. The spacer of claim 15, wherein:
the gripping means and the spacing means form a single, integral, generally U-shaped article.

20. The spacer of claim 19, wherein:
the spacing means is thicker than the gripping means, and the thickness of the spacing means determines the space between the door panel and the cabinet structure when the edge of the door panel with the spacer placed thereon is held against the cabinet structure.
